(19) United States
(12) Patent Application Publication
(10) Pub. No.: US 2009/0038233 A1
(43) Pub. Date: Feb. 12, 2009

(54) RV Door

(75) Inventors: Mitzi Aaron, Baytown, TX (US); Steve Aaron, Baytown, TX (US); Lea Demontrond, Houston, TX (US); Charles R. Houssiere, IV, Houston, TX (US)

Correspondence Address: ARNOLD & KNOBLOCH, L.L.P., 2401 FOUNTAIN VIEW DRIVE, SUITE 630, HOUSTON, TX, 77057, US

(73) Assignee: Maldas Co, Houston, TX (US)

(21) Appl. No.: 12/255,499

(22) Filed: Oct. 21, 2008

Related U.S. Application Data
(63) Continuation of application No. 11/411,375, filed on Apr. 26, 2006.
(60) Provisional application No. 60/784,347, filed on Mar. 21, 2006.

(51) Int. Cl. B60J 5/04; E06B 5/00; B60J 5/00

(52) U.S. Cl. 49/502; 49/506; 296/202

(57) ABSTRACT

Provided herein is a door for a mobile housing including a frame having an area of enclosure, with a plate disposed on the frame within the area of enclosure. Further provided is a stationary pane disposed on the frame within a portion of the area of enclosure. A movable pane is slidably disposed on the frame within a portion of the area of enclosure, having an open and a closed position. The movable pane is fitably received by the plate when in the closed position. The movable pane provides a handle access area within the area of enclosure that is operable in either the open or the closed positions of the movable pane.

### STATEMENT OF RELATED CASES

Pursuant to 35 U.S.C. 119(e)(1), reference is hereby made to earlier filed provisional Patent Application No. 60/784,347 filed Mar. 21, 2006.

### STATEMENT REGARDING FEDERALLY SPONSORED RESEARCH AND DEVELOPMENT

Not applicable.

### FIELD OF THE INVENTION

The present invention relates generally to doors for movable living quarters and, more particularly, to a secondary door for recreational vehicles, campers, or motor homes.

### BACKGROUND OF THE INVENTION

Travel trailers, campers, motor homes, and other recreational housings typically have a solid primary door, which serves to secure the recreational housing during transport. The primary door also provides a barrier between the environment inside the recreational housing and the environment outside the recreational housing, such as cold or hot weather, wind, and the like. Further, the primary door acts as a barrier to typically encountered insects, such as flies, mosquitoes, et cetera. When closed, the primary door also alerts neighboring campers that the occupants desire privacy. This signal may or may not be true, as the primary door may merely be closed to keep the interior of the recreational housing at a comfortable temperature compared to the exterior temperature.

A secondary door is sometimes attached to provide either a screen or a pane barrier when the primary door is open. Typically, the secondary door has a small panel opening, which allows access to the latch of the primary door. When needed, the small panel is opened, allowing a user's hand to go through the secondary door to grasp the latch of the primary door. Typically, the screen or pane of the secondary door is either fixed or interchangeable, but not otherwise movable, owing to the area reserved for access to the latch of the primary door.

### SUMMARY OF THE INVENTION

According to a first example of the invention, there is provided a door for a mobile housing having a frame having an area of enclosure and a closure member disposed on the frame, within the area of enclosure. A stationary pane is disposed on the frame within at least a portion of the area of enclosure. A movable pane is slidably disposed on the frame within at least a portion of the area of enclosure, the movable pane having at least an open and a closed position. The movable pane is fittably received by the closure member when the movable pane is in the closed position. The movable pane also provides a handle access area within the area of enclosure when the movable pane is in the open position and also when the movable pane is in the closed position.

According to a second example of the invention, the above-described door further has a screen slidably disposed on the frame within at least a portion of the area of enclosure. The screen has at least an open and a closed position. The screen is fittably received by the closure member when the screen is in the closed position. The screen also provides a handle access area within the area of enclosure when the screen is in the open position and also when the screen is in the closed position.

According to a third example of the invention, the closure member of the above-described door is shaped substantially similar to the access area within the area of enclosure.

According to a fourth example of the invention, the closure member of the above-described door is at least as long as the length of said area of enclosure in at least one linear dimension.

According to a fifth example of the invention, the above-described door further has a handle pane, slidably disposed on the frame. The handle pane has at least an open position, providing a handle access area when in the open position.

According to a sixth example of the invention, the above-described door further has a handle pane, slidably disposed on said stationary pane.

In further examples of the invention, the stationary pane of the above-described door is selected from the group comprising: a transparent pane, a translucent pane, an opaque pane, and a screen.

In further examples of the invention, the movable pane of the above-described door is selected from the group comprising: a transparent pane, a translucent pane, an opaque pane, and a screen.

In still further examples of the invention, the stationary pane of the above-described door comprises one or more components selected from the group essentially consisting of: glass panels, translucent acrylic panels, transparent acrylic panels, polymethyl methacrylate sheets, and polycarbonate resin thermoplastic sheets.

In still further examples of the invention, the movable pane of the above-described door comprises one or more components selected from the group essentially consisting of: glass panels, translucent acrylic panels, transparent acrylic panels, polymethyl methacrylate sheets, and polycarbonate resin thermoplastic sheets.

According to another example of the invention, there is provided a method of doorway access to a mobile housing. The method comprises the steps of selectively segregating the environment of the interior of the mobile housing from the environment of the exterior of the mobile housing; selectively screening the interior of the mobile housing from the exterior of the mobile housing; and selectively accessing a latch.

According to further examples of the invention, the environment-segregating step of the above-described method is selectable at least between an open position and a closed position. The screening step is also selectable at least between an open position and a closed position. Further, the latch-accessing step is operable in various combinations of the selected positions of the environment-segregating step and the screening step. The latch-accessing step is operable in the open position of the environment-segregating step. The latch-accessing step is operable in the closed position of the environment-segregating step. The latch-accessing step is operable in the open position of the screening step. The latch-accessing step is operable in the closed position of the screening step.

According to another example of the invention, there is provided is a system for enclosing a doorway for a mobile housing. The system includes a means for selectively segregating the environment between the interior of the housing and the exterior of the housing. The selective segregating means has at least an open mode and a closed mode. Also included is a means for selectively screening the environment between the interior of the housing and the exterior of the housing. The selective screening means has at least a deployed mode and a stowed mode. Also included is a means for selectively accessing a latch, the latch access means having at least an enabled mode and a barrier mode.

According to a further example of the invention, the enabled mode of the latch access means of the above-described system is operative in either the open mode or the closed mode of the selective segregating means.

According to a further example of the invention, the enabled mode of the latch access means of the above-described system is operative in either the deployed mode or the stowed mode of the selective screening means.

In further examples of the invention, the selective segregating means of the above-described system comprises one or more components selected from the group essentially consisting of: glass panels, translucent acrylic panels, transparent acrylic panels, polymethyl methacrylate sheets, and polycarbonate resin thermoplastic sheets.

In a further example of the invention, the selective segregating means of the above-described system comprises: a frame; a stationary pane disposed on the frame; and a movable pane disposed on the frame. The stationary pane and the movable pane enclose the doorway when the movable pane is moved away from the proximity of the stationary pane. The stationary pane and the movable pane partially enclose the doorway when the movable pane is moved towards the proximity of the stationary pane.

In a further example of the invention, the selective screening means of the above-described system comprises: a frame; a stationary pane disposed on the frame; and a screen, slidably disposed on the frame. The stationary pane and the screen enclose the doorway when the screen is moved away from the proximity of the stationary pane. The stationary pane and the screen partially enclose the doorway when the screen is moved towards the proximity of the stationary pane.

According to a further example of the invention, the latch access means of the above-described system includes a slidable handle pane, having at least an open position, the handle pane providing a handle access area when in the open position. The selective screening means provides access to the handle access area when the selective screening means is in the deployed mode as well as when in the stowed mode. Likewise, the selective segregating means provides access to the handle access area when the selective segregating means is in the open mode as well as when in the closed mode.

### BRIEF DESCRIPTION OF THE SEVERAL DRAWINGS

FIG. 1 is an exploded three-dimensional perspective view of an example of the present invention.

FIG. 2 is an assembled three-dimensional perspective view of an example of the present invention with a movable pane in an open position and a screen in an open position.

FIG. 3 is an assembled three-dimensional perspective view of an example of the present invention with a movable pane in an open position and a screen in a closed position.

FIG. 4 is an assembled three-dimensional perspective view of an example of the present invention with a movable pane in a closed position and a screen in a closed position.

FIG. 5 is an assembled three-dimensional perspective view of an example of the present invention with a movable pane in a closed position, a screen in a closed position, and a handle pane in an open position.

FIG. 6 is an assembled three-dimensional perspective view of an example of the present invention showing an elongated, full length closure member, with a movable pane in a partially closed position, a screen in a partially closed position, and a handle pane in an open position.

### DETAILED DESCRIPTION

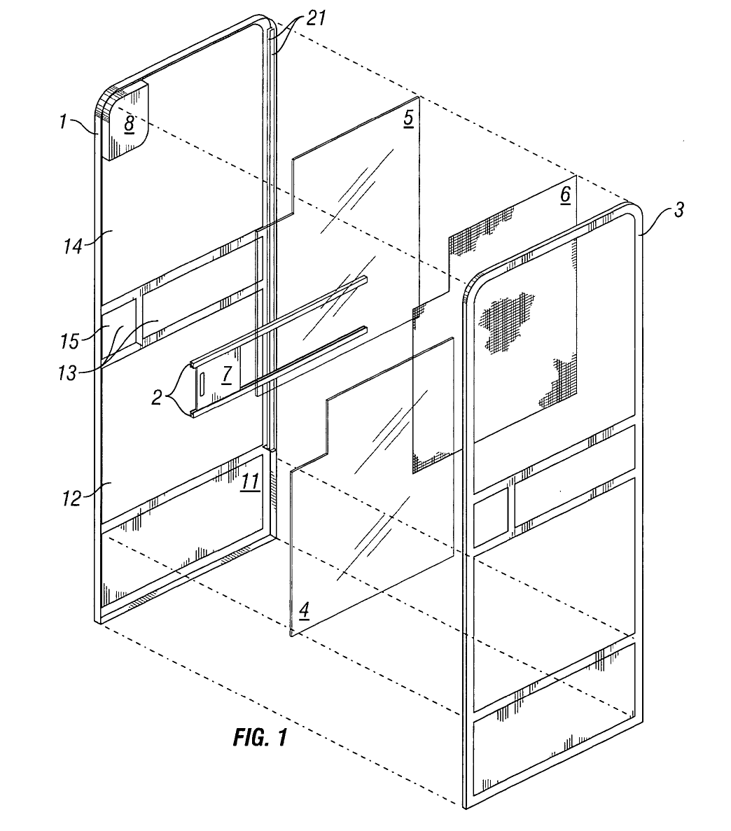

Each of FIGS. 1-6 illustrates a door and doorway enclosing system (and method of practicing same) embodying various examples of the present invention. These particular embodiments are illustrated and described herein for exemplary purposes. Variations of the door and methods of utilizing or installing the same, according to the invention, will become readily apparent to one skilled in the relevant structural or mechanical art upon reading the present Description and/or viewing the accompanying Drawings. Thus, the present invention should not be limited to the structures, systems, and methods described below.

Referring now to the drawings, and more particularly to FIG. 1, there is shown an exploded three-dimensional perspective view of the door for a mobile housing. In this embodiment, the door comprises eight major components: (1) a first frame element 1; (2) a second frame element 2; (3) a third frame element 3; (4) a stationary pane 4; (5) a movable pane 5; (6) a screen 6; (7) a handle pane 7; and (8) a closure member, plate 8. The door of the present embodiment typically is used as a secondary door, there being a primary door of generally solid structure. The primary door typically has a handle or latch for opening, positioned at some mid-level in the vertical direction and to one side in the horizontal direction. It can be appreciated that alternate embodiments exist, responding to various alternate placements of a handle or latch of a primary door.

First frame element 1 is a door structure dimensioned to encompass an area of enclosure, typically dimensioned to match the doorway of the primary door for a recreational vehicle. In the embodiment as presented, first frame element 1 is configured to divide the area of enclosure into several smaller areas. As illustrated, first frame element 1 provides an area to receive a kickplate 11, a lower opening 12 for a panel, a mid-level opening 13 to provide access to the latch of a primary door, and an upper opening 14 for a panel. Mid-level opening 13 is further divided into two open areas, one such area is an access area 15 to provide access to the latch of a primary door. Frame element 1 further provides guides or rails 21 to receive panels.

Second frame element 2 is disposed within first frame element 1, typically at a mid-level opening 13. Second frame element 2 provides a sliding guide or rail for handle pane 7. Handle pane 7 is disposed within frame element 2. In this illustrated embodiment, second frame element 2 provides a horizontal guide to allow handle pane 7 to move by sliding in a horizontal direction across a portion of the mid-level opening 13. Moving handle pane 7 allows alternate access or closure to access area 15, providing a means for selectively accessing a latch. Handle pane 7 may be moved open, providing an enabled mode allowing access to a latch. Handle pane 7 may be moved closed, providing a barrier mode preventing access to a latch and further acting as a barrier to insects or environmental conditions.

Stationary pane 4 is disposed within first frame element 1, typically in lower opening 12 above a kickplate 11. Stationary pane 4 may be any of several types of barrier material, such as a transparent, translucent, or opaque panel. A transparent material is preferred for optimum viewing through the door. Some materials available include 0.125″ sheet acrylic, with or without solar screen, glass panels, polymethyl methacrylate sheets in general, and Lexan and other polycarbonate resin thermoplastic panes or sheets.

Stationary pane 4 is typically dimensioned to enclose lower opening 12 defined by frame element 1. Stationary pane 4 is further shaped to prevent obstruction of access area 15 used to access the latch of a primary door.

In an alternate embodiment, second frame element 2 may be integrated into stationary pane 4 (not illustrated), allowing handle pane 7 to be slidably disposed on stationary pane 4.

Movable pane 5 is disposed within frame element 1, typically within guides or rails 21, allowing movable pane 5 to be slidably movable between lower opening 12 and upper opening 14. It can be appreciated that alternate embodiments exist, where absolute vertical orientation is not required, such as providing for a horizontal sliding movement, as dictated by nature of application of the present invention. The references to vertical and horizontal are merely references of relative orientation and do not imply an absolute vertical or horizontal orientation requirement.

Movable pane 5 may be any of several types of barrier material, such as a transparent, translucent, or opaque panel. A transparent material is preferred for optimum viewing through the door. Some materials available include 0.125″ sheet acrylic, with or without solar screen, glass panels, polymethyl methacrylate sheets in general, and Lexan and other polycarbonate resin thermoplastic panes or sheets. Movable pane 5 is preferably made of solid material, but in an alternate embodiment may be in the form of a mesh or screen, as a particular application may require.

Moveable pane 5 is dimensioned to be received in the lower opening 12, defined by frame element 1, and adjacently occupied by, or otherwise in proximity to, stationary pane 4. Moveable pane 5 is further dimensioned so as to be received in the upper opening 14, which is otherwise open. Movable pane 5 is further shaped to prevent obstruction of access area 15, which may be used to provide access to a latch of a primary door.

The resulting shape of movable pane 5 would prevent moveable pane 5 from completely obstructing upper opening 14, even when movable pane 5 is fully slid to a maximum vertical position. This is due to the shaping of movable pane 5 to prevent obstruction of access area 15. However, closure member plate 8 is disposed within first frame element 1, having dimensions and shape to fittably receive movable pane 5 as movable pane 5 is slid to a maximum vertical position.

In at least one embodiment, closure member plate 8 has a vertical length that is at least as long as the vertical length of access area 15, while maintaining a horizontal width that is consistent with the horizontal width of access area 15.

Third frame element 3 is disposed on first frame element 1, thereby further securing in place second frame element 2, handle pane 7, stationary pane 4, movable plane 5, and closure member plate 8.

It can be appreciated that various examples of the present invention provide opportunity for improved security of the mobile housing over the prior art. The door of the present invention may include a securing device, such as a lock, providing a level of security to the occupants of the mobile housing while allowing viewing through the doorway. This further allows the occupants to view persons approaching the door, providing the occupants with additional time to determine whether those approaching are friend, foe, or stranger. In particular, handle pane 7 may include a lock or securing means to provide an obstacle to entry or access to the latch of the primary door.

In a further embodiment, screen 6 is disposed within first frame element 1, typically within guides or rails 21 which provide vertical sliding movement between lower opening 12 and upper opening 14. Screen 6 is dimensioned to be received in lower opening 12, placing screen 6 adjacent to, or in proximity of, stationary frame 4. Screen 6 may also be adjacent to, or in proximity of, movable pane 5, depending upon the positions selected for movable pane 5 and screen 6. Screen 6 is further dimensioned so as to be received in upper opening 14. Screen 6 is further shaped to prevent obstruction of access area 15, which may be used to access the latch of a primary door, while concurrently shaped so as to be fittably received by closure member plate 8.

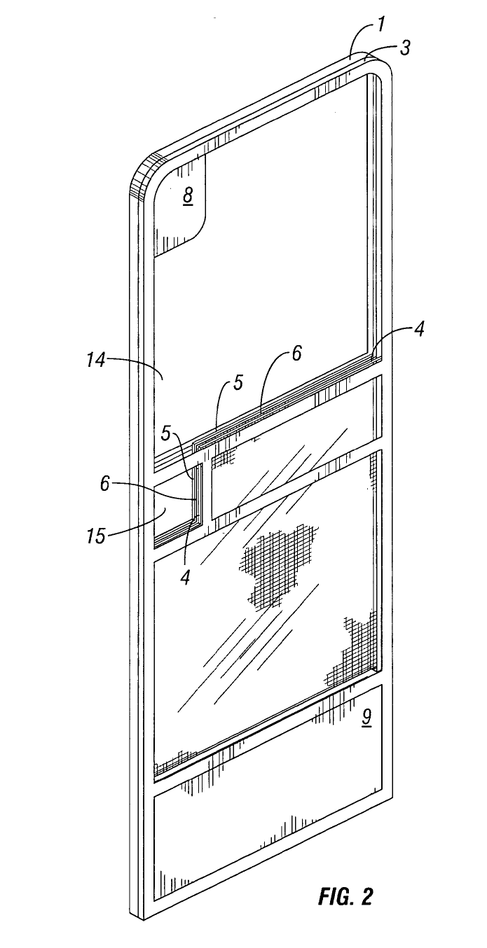

FIG. 2 illustrates an assembled three-dimensional perspective view of an example of the present invention with movable pane 5 in an open position and screen 6 in an open, or otherwise stowed, position. For clarity, handle pane 7 is not illustrated. Stationary pane 4 is shown substantially enclosing a lower opening above kickplate 11, as well as a portion of a mid-level opening. Movable pane 5 is positioned in the same lower opening, adjacent to stationary pane 4. Movable pane 5 is in an open position in this configuration. Screen 6 is likewise positioned in the same lower opening, adjacent or proximate to stationary pane 4 and adjacent to movable pane 5. Screen 6 is in an open position, or stowed mode, in this configuration. Stationary pane 4, movable pane 5, and screen 6, together, are shaped so as leave a portion of the mid-level opening open, providing an access area 15. Access area 15 may be used to provide access to a latch of a primary door, passage of mail or small objects, or other purpose. In this configuration, upper level opening 14 is open or otherwise substantially unobstructed.

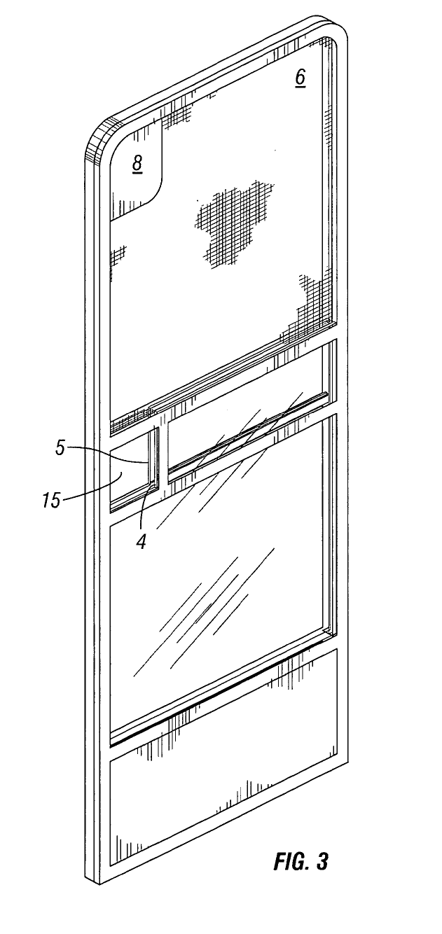

FIG. 3 illustrates an assembled three-dimensional perspective view of an example of the present invention with movable pane 5 in an open position and screen 6 in a closed, or deployed, position. For clarity, handle pane 7 is not illustrated. In this embodiment, screen 6 is positioned in an upper level opening, above the mid-level opening. In this closed position, or deployed mode, screen 6 leaves a portion of the mid-level opening open, providing an access area 15. Access area 15 may be used to provide access to a latch of a primary door, or other purpose. Stationary pane 4 and movable pane 5 provide a barrier to the lower opening. Screen 6 is fittably received by closure member plate 8. Screen 6 provides a screening barrier to the upper opening. In this configuration, the door provides a barrier to reduce the likelihood of insects or blown debris from entering the mobile housing.

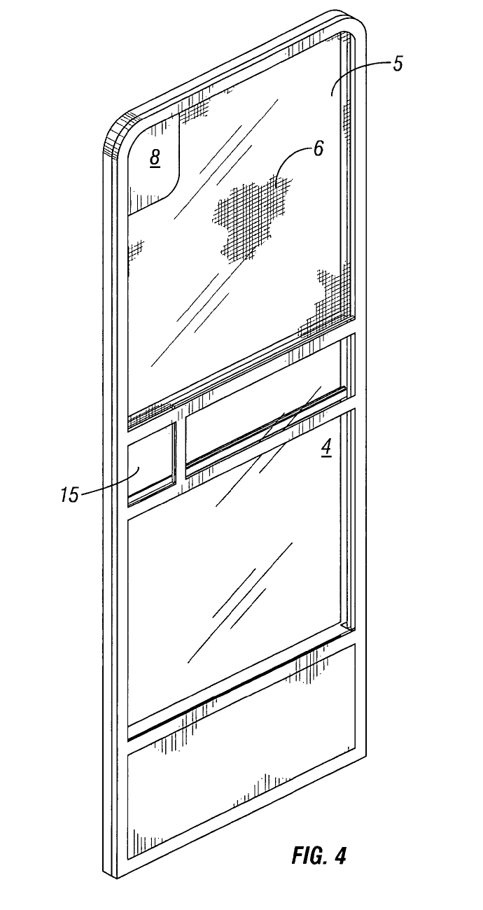

FIG. 4 illustrates an assembled three-dimensional perspective view of an example of the present invention with movable pane 5 in a closed position and screen 6 in a closed, or otherwise deployed, position. For clarity, handle pane 7 is not illustrated. In this embodiment, movable pane 5 is positioned in an upper level opening, above the mid-level opening. Movable pane 5 is fittably received by closure member plate 8. In this position, movable pane 5 leaves a portion of the mid-level opening open, providing an access area 15 which may be used to provide access to a latch of a primary door, or other purpose. Stationary pane 4 provides a barrier to the lower opening while movable pane 5 provides a barrier to the upper opening. In this configuration, the door provides an environmental barrier to reduce the rate of transfer of heat or humidity between the interior and the exterior of the mobile housing.

In an alternate embodiment, screen 6 may be positioned in an open or otherwise stowed position (not illustrated). In this position, stationary pane 4 provides a barrier to the lower opening while movable pane 5 continues to provide a barrier to the upper opening.

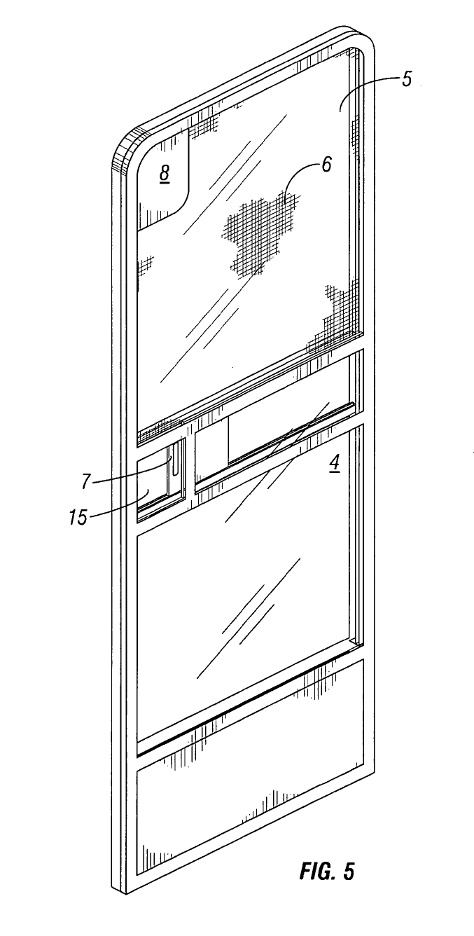

FIG. 5 illustrates an assembled three-dimensional perspective view of an example of the present invention with movable pane 5 in a closed position, screen 6 in a closed or deployed position, and handle pane 7 in an open or enabled position. Stationary pane 4 provides a barrier to the lower opening while movable pane 5 provides a barrier to the upper opening. Handle pane 7 may be positioned in an open or enabled mode to gain access to a latch of a primary door, or other use. Handle pane 7 may be positioned to provide a barrier to the remaining open area 15 of the mid-level opening, such positioning being a closed position or barrier mode for handle pane 7. A more complete overall barrier is achieved with handle pane 7 in a closed position, preventing passage of insects or environmental conditions.

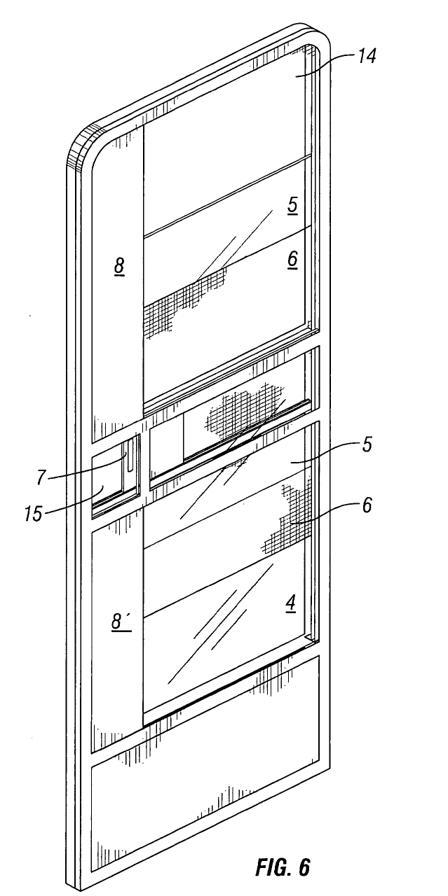

FIG. 6 illustrates a further embodiment showing closure member plate 8 having a width at least as wide as access area 15, and length extending vertically down to access area 15. Optionally, a frame or plate 8′ extends vertically below access area 15. Closure member plate 8 fitably receives movable pane 5 as movable pane 5 is moved between open and closed positions. Closure member plate 8 may also fitably receive screen 6 as screen 6 is moved between open and closed positions.

In operation, the present invention provides a system for enclosing a doorway of a mobile housing, a user being able to select from one of several desired modes of enclosure.

A user may wish to have unobstructed open access between the air inside the mobile housing and the air outside the mobile housing. Means are provided for selectively segregating the environment between the interior and the exterior of the mobile housing. In one embodiment for this mode, movable pane 5 and screen 6 are placed in their respective open positions, as illustrated in FIG. 2. Movable pane 5 and screen 6 are stowed adjacent to, or in proximity of, stationary pane 4 in the lower opening of the enclosing area. Stationary pane 4, with movable pane 5 moved in proximity of stationary pane 4, only partially encloses the doorway, providing an open area for communication of air through the doorway.

Typically, a user also wishes to access the latch of a primary door, regardless of the open or closed mode of the panes or screens. Means are provided for selectively accessing a latch through the doorway enclosing system, providing a selection between a partial opening or enabled mode and a closed or barrier mode. One embodiment, as illustrated in FIGS. 1 and 5, includes a slidable handle pane 7, having at least an open position, where handle pane 7 provides a handle or latch access area when in the enabled, open position.

In another mode, a user may wish to allow air to move substantially freely between the inside of the mobile housing and the outside of the mobile housing, but restrict insects or blown debris from entering the mobile housing. Means are also provided for selectively screening the environment between the interior and the exterior of the mobile housing. In one embodiment of this mode, movable pane 5 is placed in an open position while screen 6 is placed in a closed position, or deployed mode, as illustrated in FIG. 3. This is accomplished by deploying screen 6 from the proximity of stationary pane 4, sliding screen 6 upward to be fitably received by closure member plate 8.

In yet another mode, a user may wish to substantially reduce the communication of air, and associated temperature or humidity, between the interior of the mobile housing and the exterior. In one embodiment of this mode, movable pane 5 acts as a means for selectively segregating the environment between the interior of the housing and the exterior of the housing. Moveable pane 5 is placed in a closed position, as illustrated in FIG. 4. This is accomplished by sliding movable pane 5 away from the proximity of stationary pane 4, upward into the upper opening of the enclosing area, to be fitably received by closure member plate 8. Stationary pane 4, with movable pane 5 moved away from stationary pane 4, substantially encloses the doorway, providing a barrier to communication of air through the doorway. Screen 6 may, alternately, be stowed in an open position adjacent to stationary pane 4 (not illustrated).

The invention described herein provides a method for doorway access for a mobile housing. This method includes the steps of selectively segregating the environment between the interior and the exterior of the mobile housing while also selectively screening the interior from the exterior of the mobile housing while still also allowing selective access to a latch. In at least one embodiment, the segregating step may be selected from at least an open and a closed position while allowing selective access to a latch in either position. In at least one embodiment, the screening step is also selectable at least between an open and a closed position, while allowing selective access to a latch in either position. In still at least one further embodiment, both the segregating step and the screening step are each selectable in open or closed positions, while allowing selective access to a latch in any combination of open or closed positions.

Thus, the foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for practicing the invention, and to enable others skilled in the art to utilize the invention and such or other embodiments and with various modifications required by the particular applications or uses of the invention. It is intended that the appended claims be construed to include alternative embodiments to the extent that is permitted by prior art.

What is claimed is:

1. A door for a mobile housing comprising:
a) a frame having an area of enclosure;
b) a closure member disposed on said frame, within said area of enclosure;
c) a stationary pane disposed on said frame within at least a portion of said area of enclosure;
d) a movable pane, slidably disposed on said frame within at least a portion of said area of enclosure, having at least an open and a closed position;
e) said movable pane fittably received by said closure member when said movable pane is in said closed position; and
f) said movable pane providing an access area within said area of enclosure when said movable pane is in either said open and in said closed positions.

2. The door of claim 1 further comprising:
a) a screen, slidably disposed on said frame within at least a portion of said area of enclosure, having at least an open and a closed position;
b) said screen fittably received by said closure member when said screen is in said closed position; and
c) said screen providing an access area within said area of enclosure when said screen is in either said open and in said closed positions.

3. The door of claim 1 wherein said closure member is shaped substantially similar to said access area within said area of enclosure.

4. The door of claim 1 wherein said closure member is at least as long as the length of said area of enclosure in at least one linear dimension.

5. The door of claim 1 further comprising a handle pane, slidably disposed on said frame, having at least an open position, said handle pane providing a handle access area when in said open position of said handle pane.

6. The door of claim 1 further comprising a handle pane, slidably disposed on said stationary pane.

7. The door of claim 1 wherein said stationary pane is selected from the group comprising: a transparent pane, a translucent pane, an opaque pane, and a screen.

8. The door of claim 1 wherein said movable pane is selected from the group comprising: a transparent pane, a translucent pane, an opaque pane, and a screen.

9. The door of claim 1 wherein said stationary pane comprises one or more components selected from the group essentially consisting of: glass panels, translucent acrylic panels, transparent acrylic panels, polymethyl methacrylate sheets, and polycarbonate resin thermoplastic sheets.

10. The door of claim 1 wherein said movable pane comprises one or more components selected from the group essentially consisting of: glass panels, translucent acrylic panels, transparent acrylic panels, polymethyl methacrylate sheets, and polycarbonate resin thermoplastic sheets.

11. A method of providing doorway access to a mobile housing comprising the steps of:
selectively segregating the environment of the interior of the mobile housing from the environment of the exterior of the mobile housing;
selectively screening the interior of the mobile housing from the exterior of the mobile housing; and
selectively accessing a latch.

12. The method of providing doorway access to a mobile housing of claim 11 wherein:
said environment segregating step is selectable at least between an open position and a closed position; and
said latch accessing step is operable in either said open position and in said closed position.

13. The method of providing doorway access to a mobile housing of claim 11 wherein:
said screening step is selectable at least between an open position and a closed position; and
said latch accessing step is operable in either said open position and in said closed position.

14. The method of providing doorway access to a mobile housing of claim 11 wherein:
said environment segregating step is selectable at least between an open position and a closed position;
said screening step is selectable at least between an open position and a closed position;
said latch accessing step is operable in either said open position of said environment segregating step and in said closed position of said environment segregating step; and
said latch accessing step is operable in either said open position of said screening step and in said closed position of said screening step.

15. A system for enclosing a doorway for a mobile housing comprising:
a) a means for selectively segregating the environment between the interior of said housing and the exterior of said housing, said selective segregating means having at least an open mode and a closed mode;
b) a means for selectively screening the environment between the interior of said housing and the exterior of said housing, said selective screening means having at least a deployed mode and a stowed mode; and
c) a means for selectively accessing a latch, said latch access means having at least an enabled mode and a barrier mode.

16. The system of claim 15 wherein said enabled mode of said latch access means is operative in either said open mode or said closed mode of said selective segregating means.

17. The system of claim 15 wherein said enabled mode of said latch access means is operative in either said deployed mode or said stowed mode of said selective screening means.

18. The system of claim 15 wherein said selective segregating means comprises one or more components selected from the group essentially consisting of: glass panels, translucent acrylic panels, transparent acrylic panels, polymethyl methacrylate sheets, and polycarbonate resin thermoplastic sheets.

19. The system of claim 15 wherein said selective segregating means comprises:
a frame;
a stationary pane disposed on said frame;
a movable pane disposed on said frame;
said stationary pane and said movable pane enclosing the doorway when said movable pane is moved away from the proximity of said stationary pane; and
said stationary pane and said movable pane partially enclosing the doorway when said movable pane is moved towards the proximity of said stationary pane.

20. The system of claim 15 wherein said selective screening means comprises:
a frame;
a stationary pane disposed on said frame;
a screen, slidably disposed on said frame;
said stationary pane and said screen enclosing the doorway when said screen is moved away from the proximity of said stationary pane; and
said stationary pane and said screen partially enclosing the doorway when said screen is moved towards the proximity of said stationary pane.

21. The system of claim 15 wherein said selectable latch access means comprises:
a slidable handle pane, having at least an open position, said handle pane providing a handle access area when in said open position;
said selective screening means providing access to said handle access area when said selective screening means is in either said deployed mode and in said stowed mode; and
said selective segregating means providing access to said handle access area when said selective segregating means is in either said open mode and in said closed mode.
